(19) United States
(12) Patent Application Publication
(10) Pub. No.: US 2026/0332925 A1
(43) Pub. Date: Oct. 22, 2026

(54) SEAMLESS VEHICLE SURFACE INCLUDING A SPEAKER GRILLE PATTERN

(71) Applicant: GM GLOBAL TECHNOLOGY OPERATIONS LLC, Detroit, MI (US)

(72) Inventors: Russell Ankenbrandt, Troy, MI (US); Lane G. Lindstrom, Oxford, MI (US)

(21) Appl. No.: 19/182,693

(22) Filed: Apr. 18, 2025

(51) Int. Cl. H04R 1/02

(52) U.S. Cl. CPC H04R 1/023; H04R 1/025; H04R 2201/029; H04R 2499/13

(57) ABSTRACT

A mold includes a first mold member configured to form a first side of the vehicle surface member, and a second mold member configured to form a second side of the vehicle surface member. The second mold member includes a first section configured to form a first surface portion of the second side of the vehicle surface member and a second section configured to form a second surface portion of the second side of the vehicle surface member. The second mold member includes a mold cavity formed in the second section. A mold insert is mountable in the mold cavity. The mold insert includes a plurality of sides and a mold insert surface extending between the plurality of sides. The mold insert surface includes a plurality of embellishment forming members that extend, uninterrupted across the mold insert surface to one or more of the plurality of sides.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to the art of vehicle surfaces and, more particularly, to a seamless vehicle surface including a speaker grille pattern.

Vehicles include many surfaces that include various embellishments. The embellishments may be ornamental in nature such as simulated leather grain, simulated wood grain, decorative imprints, and the like. The embellishments may also be more utilitarian. For example, the embellishments may define speaker grills or openings that provide pathways for sound to pass into passenger spaces in the vehicle.

Speaker grills may take on a wide array of sizes, shapes, and construction. In some cases, a metal cover is mounted to the surface, the metal cover includes the openings that provide the pathways for sound to pass into passenger spaces. In other cases, the openings may be punched into the material. In still other cases, the embellishments are molded into the surface. A number of the embellishments are purely ornamental while other embellishments may define the openings which provide the pathway for sound to pass into the passenger spaces. When molding the surface, molds are typically provided with inserts having embellishment forming members. The embellishment forming members form the openings as well as the ornamental embellishments. The inserts may be removed and replaced when they become worn. This method allows the mold to be periodically refreshed without the need to replace entire mold sections.

Generally, the inserts are set into recesses formed in a mold section. As such, the embellishments and openings are typically surrounded by a ditch or recess. That is, there is a gap between the embellishments and edges of the insert. The gap ensures that the embellishment forming members have good structural support and that a good seal exists between the insert and the mold section so that material does not escape from the mold while being injected. The gap is manually polished to eliminate the formation of a parting line in the surface. The gap also forms a ditch or recess around the embellishments.

### SUMMARY

A mold for forming a vehicle surface member, in accordance with the present disclosure, includes a first mold member configured to form a first side of the vehicle surface member, and a second mold member configured to form a second side of the vehicle surface member. The second mold member includes a first section configured to form a first surface portion of the second side of the vehicle surface member and a second section configured to form a second surface portion of the second side of the vehicle surface member. The second mold member includes a mold cavity formed in the second section. A mold insert is mountable in the mold cavity. The mold insert includes a plurality of sides and a mold insert surface extending between the plurality of sides. The mold insert surface includes a plurality of embellishment forming members that extend, uninterrupted across the mold insert surface to one or more of the plurality of sides.

In other features, the second mold member is devoid of a ditch surrounding the mold cavity.

In other features, the plurality of embellishment forming members comprise a plurality of projections that extend outwardly from the mold insert surface.

In other features, the plurality of projections includes a first plurality of projections having a first length and a second plurality of projections having a second length that is greater than the first length.

In other features, the second plurality of projections of the plurality of embellishment forming members are configured to form openings in the vehicle surface member.

In other features, the first section of the second mold member includes a mold surface that extends to the mold cavity.

In other features, the plurality of embellishment forming members include a third plurality of projections arranged on the mold surface of the first section of the second mold member, the third plurality of projections extending uninterrupted up to at least one of the first plurality of projections and the second plurality of projections.

A method of forming a mold to produce vehicle surface members, in accordance with the present disclosure, includes forming a mold member having a mold member surface configured to form a side of the vehicle surface member, the mold member surface includes a first section configured to form a first surface portion of the side of the vehicle surface member and a second section configured to form a second surface portion of the side of the vehicle surface member. The method further includes creating a plurality of embellishment forming members including a first plurality of projections and a second plurality of projections on the mold member, the plurality of embellishment forming members extending uninterrupted across the mold member surface, and laser etching select ones of the plurality of embellishment to establish a selected height of one or more of the first plurality of projections and the second plurality of projections to establish a selected mold design.

In other features, the method includes forming a mold cavity in the second section, forming a mold insert including a plurality of sides and a mold insert surface, the mold insert being mountable in the mold cavity, and creating another plurality of embellishment forming members on the mold insert surface.

In other features, forming the plurality of embellishment forming members includes forming a plurality of projections that extend outwardly from the mold insert surface.

In other features, creating the another plurality of projections includes creating a first plurality of projections having a first length and a second plurality of projections having a second length that is greater than the first length.

In other features, forming the plurality of embellishment forming members includes electric discharge machining the plurality of embellishment forming members onto the first section of the mold member.

In other features, electric discharge machining the plurality of embellishment forming members includes forming a speaker geometry on the second section of the mold member.

In other features, laser etching select ones of the plurality of embellishment includes laser etching a speaker geometry on the mold insert surface.

In other features, the method further includes installing the mold insert into the mold cavity with the first plurality of projections extending up to the second plurality of projections.

In other features, the method further includes creating a seamless interface between the mold insert surface and the first section of the mold member.

A vehicle surface member in accordance with the present disclosure, includes a body including a first surface portion and a second surface portion, and a plurality of embellishments formed on the first surface portion of the body. The plurality of embellishments extend, uninterrupted, across the first surface portion up to the second surface portion.

In other features, select ones of the plurality of embellishments define openings that extend through the body.

In other features, the body includes an outer surface portion and an inner surface portion, the inner surface portion being configured to support a speaker attached to the inner surface portion at the openings.

In other features, the first surface portion and the second surface portion define part of a vehicle dashboard.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a right side partial perspective view of a vehicle including a speaker grille pattern formed in a seamless surface, in accordance with the present disclosure;

FIG. 2 is a top view of a vehicle surface member in the form of a dashboard, including speaker grilles formed in the seamless surface;

FIG. 3 is a back side view of one of the speaker grilles of FIG. 2, in accordance with the present disclosure;

FIG. 4 is a plan view of a mold for forming the speaker grille in the seamless surface of the vehicle surface member of FIG. 2, in accordance with the present disclosure;

FIG. 5 is a plan view of a mold member of the mold prior to laser etching a speaker grille pattern into a mold insert surface, in accordance with the present disclosure;

FIG. 6 is a plan view of the mold member of FIG. 5 after laser etching the speaker grille pattern into the mold cavity surface, in accordance with the present disclosure;

FIG. 7 is a flow chart illustrating a method of forming the mold member of FIG. 6 in accordance with the present disclosure;

FIG. 8 is a plan view of a mold member of the mold prior to laser etching a speaker grille pattern onto a mold cavity surface, in accordance with another aspect of the present disclosure;

FIG. 9 is a plan view of the mold member of FIG. 8 after laser etching the speaker grille pattern into the mold cavity surface, in accordance with the present disclosure; and

FIG. 10 is a flow chart illustrating a method of forming the mold member of FIG. 9, in accordance with an aspect of the present disclosure.

In the drawings, reference numbers may be reused to identify similar and/or identical elements.

### DETAILED DESCRIPTION

While shown in the context of a vehicle, the method for forming a seamless surface including a speaker grille pattern in accordance with the present disclosure may be used in other commercial products including non-vehicle implementations.

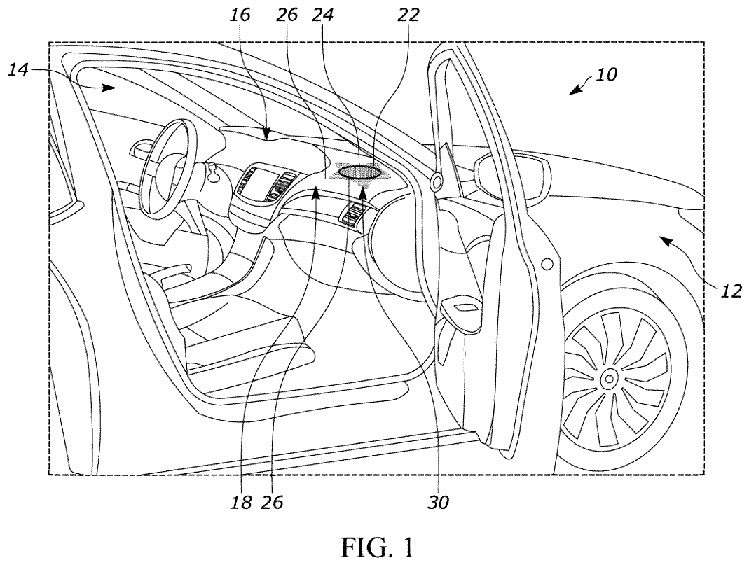

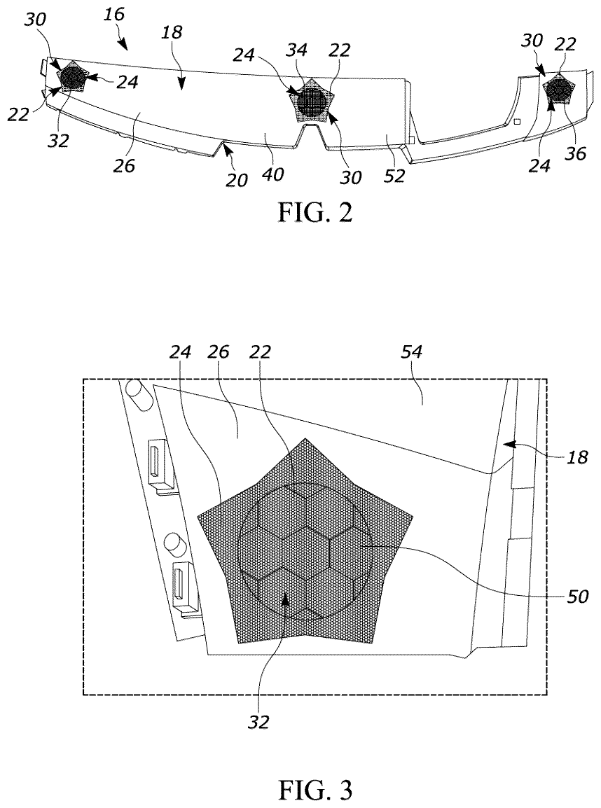

A vehicle, in accordance with the present disclosure, is indicated generally at 10 in FIG. 1. Vehicle 10 includes a body 12 including a passenger compartment 14 within which are arranged a number of vehicle surface members 16. One of the vehicle surface members 16 defines a dashboard 18. As shown in FIG. 2 and with continued reference to FIG. 1, dashboard 18 includes a dashboard body 20 having a first surface portion 22, a second surface portion 24, and a third surface portion 26. A plurality of embellishments are formed on first surface portion 22 and second surface portion 24.

The plurality of embellishments 30 on second surface portion 24 form a first speaker grille 32, a second speaker grille 34, and a third speaker grille 36. A speaker (not shown) is mounted to an underside 38 (FIG. 3) of vehicle surface member 16 at each of the first speaker grille 32, the second speaker grille 34, and the third speaker grille 36. The plurality of embellishments 30 on first surface portion 22 form a design, shown in the form of a star (not separately labeled) around each of the first speaker grille 32, the second speaker grille 34, and the third speaker grille 36. The particular nature, shape, or geometry of the design may vary as may the geometry of each of the first speaker grille 32, the second speaker grille 34, and the third speaker grille 36. Third surface portion 26 defines a substantially smooth surface 40 that extends between each second surface portion 24. At this point, it should be understood that while described as being formed on dashboard 18, speaker grilles may be formed in any number of vehicle surfaces including door surfaces, sidewall surfaces, ceiling surfaces, console surfaces, and the like.

In accordance with the present disclosure, vehicle surface member 16 is devoid of a ditch surrounding first surface portion 22 and second surface portion 24. The term “ditch” should be understood to define a smooth, unadorned, region that surrounds the first surface portion 22 and the second surface portion 24. The “ditch” is an artifact of the manufacturing process for creating a plurality of openings 50 that define, for example, first speaker grille 32.

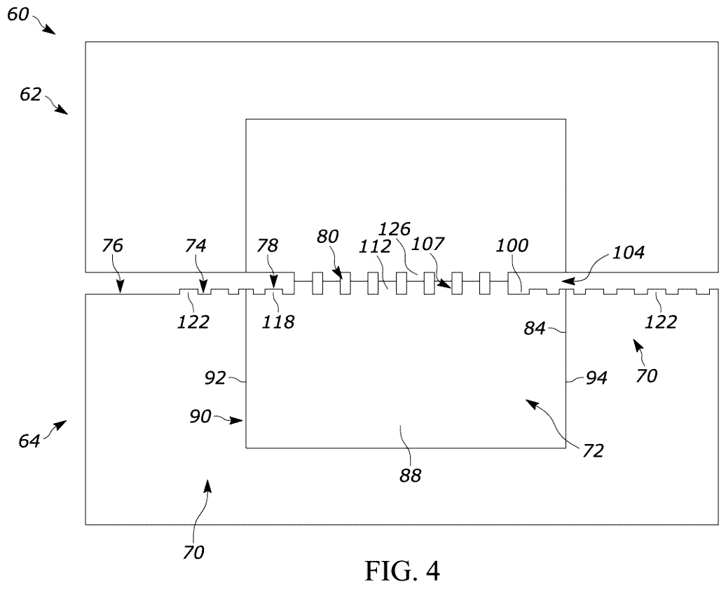

In accordance with the present disclosure, the vehicle surface member 16 is formed in a mold 60 a portion of which is shown in FIG. 4. Mold 60 includes a first injection mold cavity or first mold member 62 and a second injection mold cavity or second mold member 64. First mold member 62 forms an outer surface of vehicle surface member 16 and second mold member forms the inner surface of vehicle surface member 16. First mold member 62 and second mold member 64 are brought together to form the plurality of embellishments 30 on first surface portion 22 and second surface portion 24 as will be detailed more fully herein.

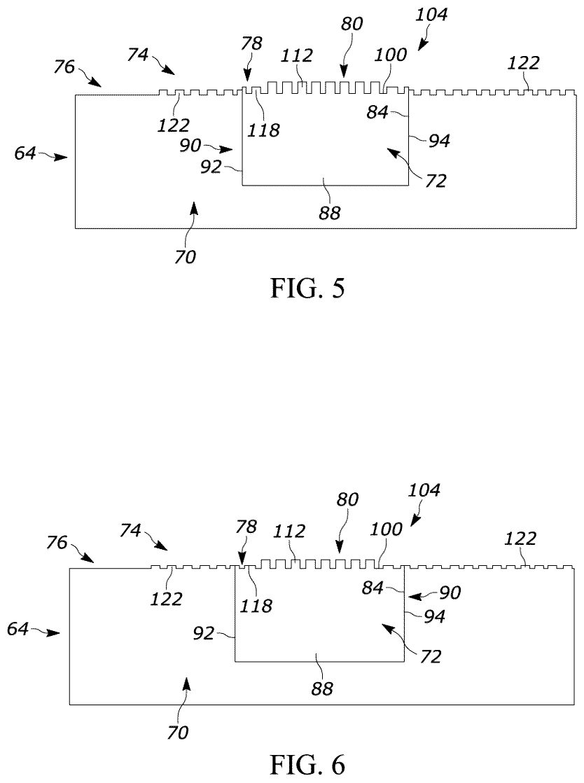

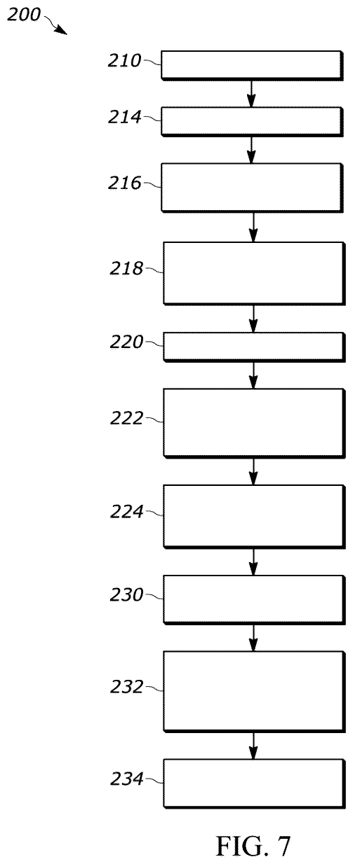

Reference will now follow to FIG. 5 and with continued reference to FIG. 4 in describing second mold member 64. Second mold member 64 includes a first section or mold cavity member 70 and a second section or mold insert member 72. Second section 72 defines a cavity block (not separately labeled) as will become more readily apparent herein. First section 70 defines a first mold surface portion 74 and a second mold surface portion 76. Second section 72 includes a first surface portion 78 and a second surface portion 80. A mold cavity 84 is formed in second section 72. Mold cavity 84 is receptive of a removeable mold insert 88 that forms, for example, first speaker grille 32.

In accordance with the present disclosure, mold insert 88 includes a plurality of sides 90 including a first side 92, a second side 94 that is opposite first side 92, a third side (not shown), and a fourth side (also not shown). The third side and the fourth side extend between and connect with first side 92 and second side 94. Mold insert 88 includes an outer, mold insert surface 100 that extends across first surface portion 78 and second surface portion 80 of second section 74.

Mold insert 88 includes a plurality of embellishment forming members 104 extending across mold insert surface 100 uninterrupted between first side 92 and second side 94. Embellishment forming members 104 may also extend uninterrupted between the third side and the fourth side. Additional embellishment forming members 104 may also extend across a portion of first section 70.

Embellishment forming members 104 may include a first plurality of projections 112 and a second plurality of projections 118 formed across mold insert surface 100. Embellishment forming members 104 may also include a third plurality of projections 122 formed on first surface 74 of first section 70. Embellishment forming members 104 may be formed on first surface 74 of first section 70, and first surface portion 78 and second surface portion 80 of second section 72 through various material forming methods including an electric discharge machining (EDM) process, a cutting process, a laser cutting process, a milling a process, or the like. The plurality of embellishment forming members 104 may be formed in a variety of different patterns. The different patterns may be provided as an option for consumers that purchase vehicle 10.

In accordance with an aspect of the present disclosure, after forming the embellishment forming members 104, they may be trimmed through a laser etching process. For example, the first plurality of projections 112 may be trimmed to a first height, the second plurality of projections 118 may be trimmed to a second height, and the third plurality of projections 122 may be trimmed to a third height. The first plurality of projections may be longer than each of the second plurality of projections 118 and the third plurality of projections 122.

For example, when mold 60 is assembled, such as shown in FIG. 4, the first plurality of projections 112 may contact corresponding projections 126 on first mold member 62. In this manner, the first plurality of projections form openings 50 that allow sound to pass from the speaker through vehicle surface member 16. The second plurality of projections 118 and the third plurality of projections 122 may be trimmed to differing heights to form a selected ornamental pattern that defines or surrounds the first speaker grille 32.

Reference will now follow to FIG. 7 in describing a method 200 of forming second mold member 64, in accordance with the present disclosure. Method 200 includes forming second mold member 64 in block 210. In block 214, second mold member 64 begins to take shape. In block 216 mold cavity 84 is formed in second mold member 64. The third plurality of projections 122 may then be formed on first portion 74 in block 218 through, for example, an EDM process. Also, in block 21`8 the third plurality of projections 122 may then be formed or shaped on first portion 74 though a laser etching process.

Mold insert 88 is formed in block 220. That is, mold insert 88 is machined and sized to fit seamlessly into mold cavity 84 in block 220. In block 222, mold insert 88 is spotted into mold cavity 84. In block 224 the plurality of embellishment forming members 104, e.g., first plurality of projections 112 and the second plurality of projections 118 are formed on mold insert surface 100 through, for example, an EDM process. Of course, it should be understood that a variety of processes may be used to form the first plurality of projections and the second plurality of projections 118. In other words, block 224 is not limited to EDM processes. The first plurality of projections 112 and the second plurality of projections 118 are formed to have a selected geometry.

In block 230, mold insert 88 is fitted into mold cavity 84. In block 232 the first plurality of projections 112, the second plurality of projections 118, and the third plurality of projections 122 are trimmed to a selected height through, for example, a laser etching process. Of course, other processes for trimming the first plurality of projections 112, the second plurality of projections 118, and the third plurality of projections 122 may also be employed. After trimming, the first plurality of projections 112 are longer than each of the second plurality of projections 128 and third plurality of projections 122 so as to form openings 50. In block 234 second mold member 64 is completed ensuring that a seamless interface exists between mold insert 88 and first section 70 of second mold member 64.

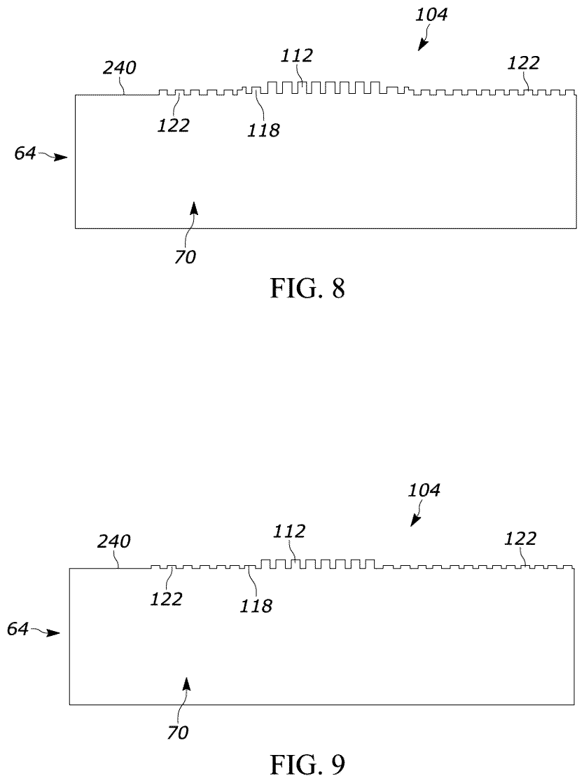

Reference will now follow to FIGS. 8, 9, and 10 in describing second mold member 64 in accordance with another exemplary aspect. Depending on design parameters, e.g., size, shape, and geometric details of the speaker grille, second mold member 64 may be formed without a cavity or the need for an insert. In some cases, second mold member 64 may include a continuous outer surface 240 as shown in FIG. 8. In accordance with an exemplary aspect, the first plurality of projections 112, the second plurality of projections 118, and the third plurality of projections 122 may be formed directly onto continuous outer surface 240. After being formed, the first plurality of projections 112, the second plurality of projections 118, and the third plurality of projections 122 may be trimmed to a selected height.

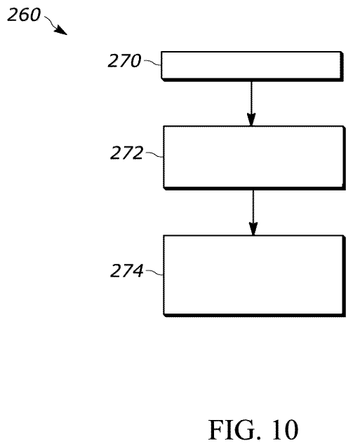

Reference will now follow to FIG. 10 in describing a method 260 of forming second mold member 64, in accordance with the present disclosure. Method 260 includes forming second mold member 64 in block 270. In block 272, the first plurality of projections 112, the second plurality of projections 118, and the third plurality of projections 122 are firmed on continuous outer surface 240. The first plurality of projections 112, the second plurality of projections 118m and the third plurality of projections 122 may be formed through various material forming methods including an electric discharge machining (EDM) process, a cutting process, a laser cutting process, a milling a process, or the like.

In block 274, select ones of the plurality of embellishment forming members 104, e.g., first plurality of projections 112, second plurality of projections 118, and the third plurality of projections 122 are trimmed to a selected height through, for example, a laser etching process. Of course, other processes for trimming the first plurality of projections 112, the second plurality of projections 118, and the third plurality of projections 122 may also be employed. After trimming, the first plurality of projections 112 are longer than each of the second plurality of projections 128 and third plurality of projections 122 so as to form openings 50.

At this point it should be appreciated that the disclosed process forms a vehicle component having a seamless finish. That is, there are no mold lines around speaker grilles formed in the surface. Further, the present disclosure allows vehicle manufacturers to form a more seamless and aesthetically pleasing appearance on vehicle surfaces. Additionally, the systems and methods of the present disclosure allow manufacturers to offer customers options for selecting and even designing personal speaker grill geometries and/or an option to form selected decorative embellishments about the speaker grille or in other surface areas.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

When the terms “about” or “substantially” are used in this specification in connection with a numerical value, it is intended that the associated numerical value includes a manufacturing or operational tolerance (e.g., ±10%) around the stated numerical value. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

The terms “a” and “an” do not denote a limitation of quantity, but rather denote the presence of at least one of the referenced item. The term “or” means “and/or” unless clearly indicated otherwise by context. Reference throughout the specification to “an aspect,” means that a particular element (e.g., feature, structure, step, or characteristic) described in connection with the aspect is included in at least one aspect described herein and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A mold for forming a vehicle surface member comprising:
a first mold member configured to form a first side of the vehicle surface member; and
a second mold member configured to form a second side of the vehicle surface member, the second mold member including a first section configured to form a first surface portion of the second side of the vehicle surface member and a second section configured to form a second surface portion of the second side of the vehicle surface member, the second mold member including a mold cavity formed in the second section; and
a mold insert mountable in the mold cavity, the mold insert including a plurality of sides and a mold insert surface extending between the plurality of sides, the mold insert surface includes a plurality of embellishment forming members that extend, uninterrupted across the mold insert surface to one or more of the plurality of sides.

2. The mold according to claim 1, wherein the second mold member is devoid of a ditch surrounding the mold cavity.

3. The mold according to claim 1, wherein the plurality of embellishment forming members comprise a plurality of projections that extend outwardly from the mold insert surface.

4. The mold according to claim 3, wherein the plurality of projections includes a first plurality of projections having a first length and a second plurality of projections having a second length that is greater than the first length.

5. The mold according to claim 4, wherein the second plurality of projections of the plurality of embellishment forming members are configured to form openings in the vehicle surface member.

6. The mold according to claim 5, wherein the first section of the second mold member includes a mold surface that extends to the mold cavity.

7. The mold according to claim 6, wherein the plurality of embellishment forming members include a third plurality of projections arranged on the mold surface of the first section of the second mold member, the third plurality of projections extending uninterrupted up to at least one of the first plurality of projections and the second plurality of projections.

8. A method of forming a mold to produce vehicle surface members, the method comprising:
forming a mold member having a mold member surface configured to form a side of the vehicle surface member, the mold member surface including a first section configured to form a first surface portion of the side of the vehicle surface member and a second section configured to form a second surface portion of the side of the vehicle surface member;
creating a plurality of embellishment forming members including a first plurality of projections and a second plurality of projections on the mold member, the plurality of embellishment forming members extending uninterrupted across the mold member surface; and
laser etching select ones of the plurality of embellishment to establish a selected height of one or more of the first plurality of projections and the second plurality of projections to establish a selected mold design.

9. The method of claim 8, further comprising:
forming a mold cavity in the second section;
forming a mold insert including a plurality of sides and a mold insert surface, the mold insert being mountable in the mold cavity; and
creating another plurality of embellishment forming members on the mold insert surface.

10. The method of claim 9, wherein forming the plurality of embellishment forming members includes forming a plurality of projections that extend outwardly from the mold insert surface.

11. The method of claim 10, wherein creating the another plurality of projections includes creating a first plurality of projections having a first length and a second plurality of projections having a second length that is greater than the first length.

12. The method of claim 11, wherein forming the plurality of embellishment forming members includes electric discharge machining the plurality of embellishment forming members onto the first section of the mold member.

13. The method of claim 12, wherein electric discharge machining the plurality of embellishment forming members includes forming a speaker geometry on the second section of the mold member.

14. The method of claim 10, wherein laser etching select ones of the plurality of embellishment includes laser etching a speaker geometry on the mold insert surface.

15. The method of claim 10, further comprising:
installing the mold insert into the mold cavity with the first plurality of projections extending up to the second plurality of projections.

16. The method of claim 15, further comprising creating a seamless interface between the mold insert surface and the first section of the mold member.

17. A vehicle surface member comprising:
a body including a first surface portion and a second surface portion; and
a plurality of embellishments formed on the first surface portion of the body, the plurality of embellishments extending, uninterrupted across the first surface portion up to the second surface portion.

18. The vehicle surface member according to claim 17, wherein select ones of the plurality of embellishments define openings that extend through the body.

19. The vehicle surface member according to claim 18, wherein the body includes an outer surface portion and an inner surface portion, the inner surface portion being configured to support a speaker attached to the inner surface portion at the openings.

20. The vehicle surface member according to claim 17, wherein the first surface portion and the second surface portion define part of a vehicle dashboard.
